(19) United States
(12) Patent Application Publication
(10) Pub. No.: US 2007/0085686 A1
(43) Pub. Date: Apr. 19, 2007

(54) Tracking of disposable components

(75) Inventor: Dan OZ, Even Yehuda (IL)

Correspondence Address: BRUCE E. LILLING;LILLING & LILLING PLLC, P.O. BOX 560, GOLDEN BRIDGE, NY, 10526, US

(73) Assignee: STRYKER GI, LTD, Haifa (IL)

(21) Appl. No.: 11/419,518

(22) Filed: May 22, 2006

Related U.S. Application Data
(60) Provisional application No. 60/684,153, filed on May 24, 2005.

(51) Int. Cl. G08B 13/14; G06K 19/06

(52) U.S. Cl. 340/572.8; 235/492

(57) ABSTRACT

The present invention concerns monitoring and tracking of disposable components employed in endoscopes. In particular the invention is described in connection with tracking of a disposable component of a gastrointestinal endoscope. The disposable component is provided with a passive RFID tag programmed with identification information. The RFID tag is capable upon energizing by a transceiver of transmitting the identification information to the transceiver.

### BACKGROUND OF THE INVENTION

1. Field of the Invention

The present invention relates to tracking of disposable items in order to prevent their intentional or inadvertent reuse, their unauthorized use or use of disapproved, non-ingenious items. More particularly the present invention concerns monitoring and tracking of various medical disposable items, which are employed in various types of endoscopes for examination of body passages and cavities for abnormalities. Even more particularly, the present invention refers to monitoring and tracking of disposable items, which are used mostly in gastroenterology. The present invention is especially relevant to gastroenterology endoscopes provided with disposable covering sleeves, which protect the insertion tube from contamination. If the endoscope is used as a colonosocope, such a sleeve might at the same time assist, upon inflation, in propelling the endoscope within the colon.

Among disposable items, which are associated with such colonoscopes and should be monitored, one can mention single-use surgical tools, like biopsy forceps, snares, baskets etc., components of sheathing assemblies for single-use tools, internal working channels, e.g. single-lumen or multilumen tubings, caps for covering optical head, tubes for connecting with control unit and so on.

It should be borne in mind, however, that the present invention is not limited strictly to tracking disposable items referring to endoscopes used in gastroeneterology and that it is suitable for preventing reuse of disposable items associated with any other endoscopes or other medical devices as well.

2. Brief Description of the Related Art

The use of a disposable sleeve (also referred to as a sheath) to cover an endoscope is well known in the art. Flexible endoscopes, such as colonoscopes, are notoriously difficult to clean and disinfect thoroughly, leading to problems of cross-contamination between patients and between patients and staff. These problems can be partially avoided by covering the endoscope with a disposable sleeve, which is discarded after use. By using disposable sleeves it is possible to avoid labor and time consuming re-processing steps associated with disinfections of the colonoscope between adjacent colonsocopic examinations. By using disposable sleeves it is possible also to prevent cross-contamination. It can be readily appreciated that after the endoscopic procedure is finished, the disposable sleeve becomes a potential source for contamination and its reuse must be prevented.

Furthermore, endoscopes commonly have working channels, running from a proximal port outside the body to a distal port at the distal end of the endoscope. When the distal end of the endoscope is inserted into the body, the working channel may be used, inter alia, to pass a surgical instrument through to the distal end of the endoscope in order to perform a surgical procedure, such as a biopsy. Instruments that are used in this manner become contaminated with biological matter from inside the patient's body. As the instrument is withdrawn from the body, it spreads the contamination to the interior of the working channel and to the proximal port of the endoscope and eventually to the operator's hands. Therefore reuse of such instrument without disinfection/sterlization must be also prevented.

Embodiments of the present invention are particularly (although not exclusively) suitable for use with endoscopes, which are provided with sheathing systems for covering the outer surface of an endoscope, such as described in Eizenfeld (WO 2004/016299; PCT patent application PCT/IL2003/000661), which is incorporated herein by reference, or for use with the endoscopes provided with other sheathing systems known in the art. Such sheathing systems typically include disposable components, e.g. disposable dispenser assemblies for retaining the sleeve before use, disposable working channels or a disposable internal sleeve that fits inside the working channel of the endoscope and protects it from contamination.

It is known in the art also an apparatus for sheathing an endoscopic tool as described in Aizenfeld (WO 2005/023100; PCT patent application PCT/IL2004/000710), which is incorporated herein by reference.

The sheathing techniques employed in the apparatus described in this application are used to cover the endoscopic tool outside the body, after it has been withdrawn from the working channel. Optionally, the tool may subsequently be advanced again distally out of the sheath and into the working channel, and afterwards be retracted back proximally into the sheath. When the endoscopic procedure is finished, the tool can be disposed off and its sleeve must be disposed. The present invention is intended to prevent an inadvertent reuse of the sheath.

On the other hand it is well known in the art to use so called Radio Frequency Identification Devices or RFID for monitoring and tracking objects used in various applications, including medical devices.

An RFID system consists of two main components. The first main component is an antenna and a transceiver and a processing device, which sends RF energy and an interrogating signal (if necessary) to a transponder and then receives an RF response signal from the transponder and transfers it to a processing device. The second main component is a transponder, or tag, which is an integrated circuit containing RF circuitry programmed with information to be transmitted and an antenna.

RFID systems can be used for monitoring people, animals or physical objects used anywhere, including medical field.

In Butterfield (US Pub. No. 2004/0193453) is described an infusion data communication system, which employs RFID to ensure that the right medication is administered to the right patient through the right pump. This system is not designed for and is not capable of preventing reuse of a disposable item of an endoscope.

In WO2004008387 is disclosed a system for monitoring medical devices, such as pharmaceuticals and prescriptions. The system includes an RFID tag embedded in the cover of a container for the pharmaceutical or prescription and a reader that interrogates the tag and updates a database regarding the condition of the tag. The information in the tag can be revised by the reader or by an associated detector as the condition of the medical device changes. This system is not designed for and is not suitable for monitoring and tracking such disposable items, like flexible sheaths and sleeves employed in endoscopes in general and colonoscopes in particular.

### SUMMARY OF THE INVENTION

The present invention seeks to provide a solution for preventing reuse of various disposable components employed in endoscopic apparatuses so as to ensure that only authorized disposable components are used. This is achieved by providing the disposable components with an RFID tag enabling their reliable monitoring and tracking and at the same time preventing their inadvertent reuse and preventing use of components fitted with inappropriate RFID tag or not having a tag at all.

The main object of the present invention is providing a new method and system for monitoring and tracking of various information identifying disposable components associated with endoscopic apparatuses.

Another object of the present invention is providing a new method and system for monitoring and tracking, which employs RFID tag attached to the disposable component of an endoscopic apparatus.

For a better understanding of the present invention as well of its benefits and advantages, reference will now be made to the following description of various exemplary embodiments taken in combination with the accompanying drawings.

### BRIEF DESCRIPTION OF THE DRAWINGS

FIG. 1 is a schematic illustration of an endoscopic apparatus provided with an RFID tag system;

FIG. 2 is a cross-sectional, enlarged view of a distal end of an endoscope provided with an RFID tag deployed on a disposable item and with the front-end interrogator/reader deployed on the insertion tube;

FIG. 3 is a schematic illustration of a hardware block diagram depicting interaction between the RFID tag and the interrogator/reader;

FIG. 4 is a flow chart showing the procedure which is implemented during operation of an RFID tag; FIG. 1 is a of the present invention.

### DETAILED DESCRIPTION OF THE INVENTION

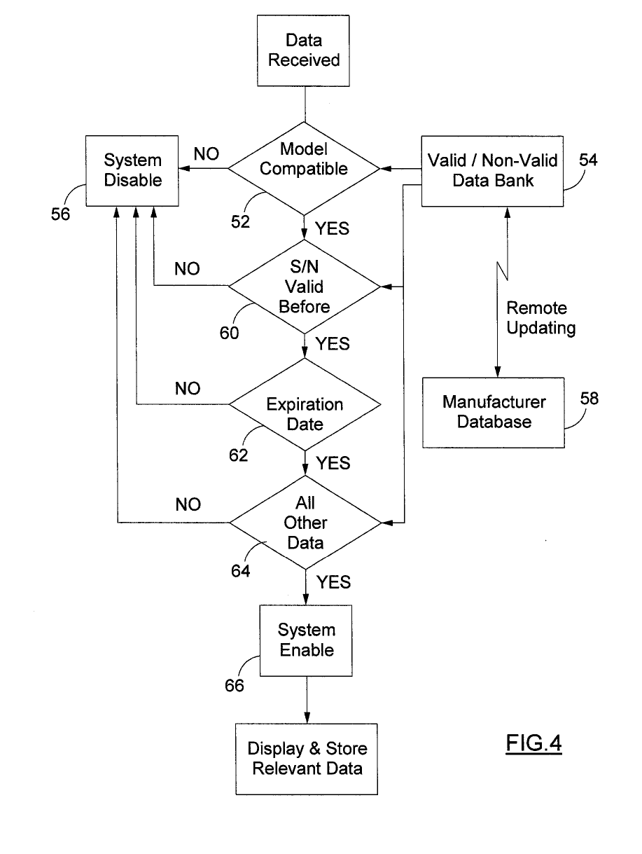

With reference to FIG. 1 the endoscopic apparatus of the present invention is shown preferably as a colonoscopic apparatus 10 with its following main components. The apparatus comprises an endoscope having insertion tube 12 with its proximal section connected to an operation handle 14 and with its distal section 16 inserted in and protruding from a disposable dispenser 18. It is seen also in FIG. 1 that a sleeve covers distal section 16 of the endoscope. That part of the sleeve, which is seen in FIG. 1, comprises a frontal non-inflatable portion 20 and a rear, folded portion 22. The frontal portion of the sleeve covers the distal section of the endoscope and its head. The frontal portion does not inflate when the endoscope advances within the colon. The rear portion covers the insertion tube and unfolds when air or other fluid medium is supplied to the sleeve. By virtue of this provision the sleeve feeds out from the dispenser, covers and propels the endoscope within the body passage. Explanation of this phenomenon can be found in the above referred-to references. The endoscope of the present invention is of similar type in the sense that it employs the same propelling mechanism, which is based on inflation of the flexible disposable sleeve coupled to the endoscope. It should be appreciated, however, that the endoscope of the present invention is not limited merely to colonoscopic apparatuses. It can be employed in any other endoscopic apparatus intended for inspection of the interior of a body passage or cavity and employing a disposable covering sheath.

It is seen also in FIG. 1, that the handle is connected by appropriate umbilical duct 24 to a control unit 26 provided with a source of compressed air for inflating and venting the sleeve and with a monitor. Proximate to the control unit a flask 28 is provided, which is filled with water, to be supplied under pressure into the colon for irrigation. Water and air are supplied to the handle through dedicated tubes attachable to the umbilical duct.

One should bear also in mind that within the insertion tube are provided various devices, which are necessary for proper functioning of the endoscope. These devices are known per se. Among such devices one can mention vertebrae and strings, which can be manipulated by the operation handle, and a multilumen tubing with appropriate passages for supplying water, as required for irrigation, or vacuum, as required for suction.

The multilumen tubing also is provided with a dedicated passage for introducing surgical instruments into the colon as might be required during a colonoscopic procedure. Along the insertion tube might extend also a dedicated tube through which air is supplied as required for inflating the sleeve. The multilumen tubing extends through the endoscope and through the handle to a connector means 30, which provides flow communication between lumens of the multilumen tubing and tubes passing along the umbilical duct tubes and supplying air and vacuum to the insertion tube from the control unit and water from the flask.

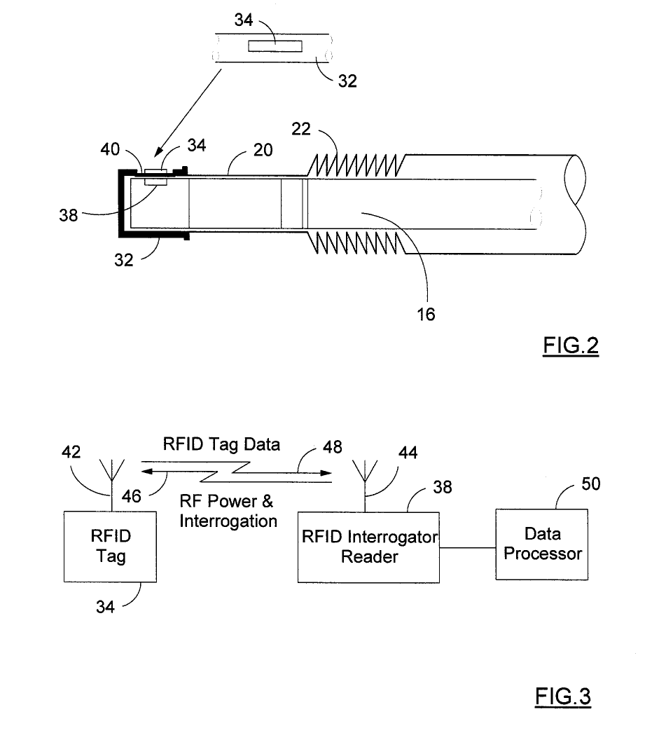

With reference to FIG. 2 it is seen the distal end of the insertion tube 16 with attached thereto a cap 32 having a window fitted with transparent closure. Through this window illuminating light can propagate and thus viewing optics of a camera head may observe the interior of a body passage when the endoscope is inserted therein.

All above-mentioned disposable components (inflatable sleeve 22, dispenser 18, multilumen tubing, cap 32 and tubes passing along the umbilical duct) are manufactured from plastic material; they are cheap, disposable items, which are discarded at the end of the colonoscopic procedure after evacuation of the insertion tube from the colon. By virtue of this provision preparation of the endoscopic apparatus for a new endoscopic procedure is simple, convenient and fast. Furthermore, by virtue of the above-mentioned disposable components, contamination of the insertion tube from within the gastroenterological tract is prevented.

The present invention makes it possible to monitor, track and validate the information associated with at least one of the disposable items, employed in the endoscopic apparatus. This possibility is achieved by providing the endoscopic apparatus with a passive RFID tag deployed on the disposable item and with an interrogator/reader, which is capable upon receiving a signal from the processing device to transmit an interrogation signal to the tag so as to power it, interrogate and then, upon receiving modulated response signal from the tag, to read and process the information stored in the tag.

In the further disclosure the RFID tag comprises a passive transponder, which is an integrated circuit containing the RF circuitry along with a logic circuitry programmed therein with the data to be transmitted.

By the reader here is meant a device that supplies RF energy to the passive RFID tag and is capable to modify and/or extract the data contained in the modulated response signal. The reader also transmits this received data to a processing unit for validation. In some cases, in addition to supplying energy to the RFID tag, the reader is capable of interrogating the data. Therefore it will be referred-to further as interrogator/reader. It should be borne in mind however that within the scope of the present invention are also readers, which are not intended for interrogation.

Referring again to FIG. 1 it is shown that on the cap 32 an RFID tag 34 is deployed. In addition to RFID tag 34 or instead of it, there is provided an RFID tag 36 that is deployed on the dispenser 18. Associated with the RFID tag 34, a front-end interrogator/reader 38 is provided, which is deployed on the distal end of the insertion tube near to the RFID tag. It should be borne in mind, however, that the front-end interrogator/reader 38 could be optionally deployed within the control unit 26. The advantage of this arrangement is associated with the possibility to keep the size of the insertion tube as small as possible. However one should bear in mind that due to the remote disposition of the front-end interrogator/reader, it might require more power for powering the RFID tag.

The front-end interrogator/reader for the RFID tag 36 is not shown, however it similarly can be deployed either on the insertion tube in vicinity of the RFID tag or within the control unit. One skilled in the art should appreciate that, instead of separate interrogators/readers, a common interrogator/reader could be employed, which is capable to communicate with several RFID tags deployed on various disposable components. It should be also appreciated that the interrogator/reader irrespective of being a common one or a separate one would be electrically connected with the control unit by suitable wiring.

The RFID tag can be secured on the cap by different ways, e.g. by gluing to the cap's periphery or by molding within a dedicated recess 40 made on the cap's periphery or by any other suitable method.

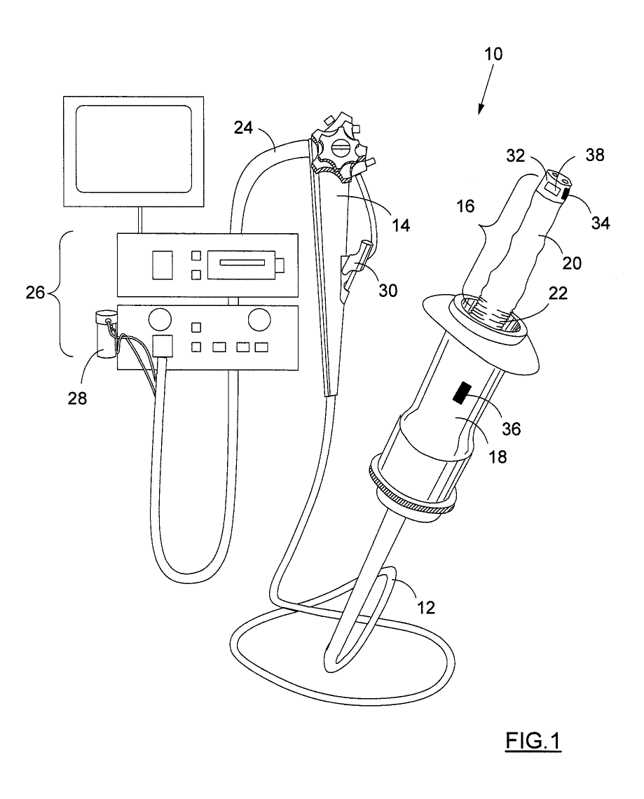

As seen in FIG. 3 both the tag 34 and the front-end interrogator/reader 38 have respective integrated antennae 42, 44. During operation the interrogator/reader 38 transmits an RF power interrogation signal 46 to the RFID tag 34 and receives in response a modulated response signal 48 returned by the tag. The response signal contains information stored in the tag e.g. serial number of the disposable item, its lot number, name of its manufacturer, its model number, its end of use date, its shipping date and so on. Furthermore, the information stored in the tag can contain the data regarding the inspection, inventory and distribution of the disposable item.

The response signal proceeds from the interrogator/reader to a data processing device 50, which is capable to process and to compare it with the data stored for the purpose of validation. The processing and comparison can be carried according to a method, which will be explained later on. The method allows comparing the information stored in the tag with a validation data stored within a dedicated database provided in the processor. It might be advantageous if the method employs a generator of random numbers for identification of disposable components to be interrogated. The processor and the database can be located either within the control unit 26 or within a dedicated separated item. It is also advantageous if the database with the validation data and/or the method would be accessible for update from the outside e.g. via the Internet, external computer, etc.

If upon validation procedure the information stored in the RFID tag does not match the data referring to an invalid disposable component (e.g. obsolete), the processor will generate a termination signal, which stops functioning of various components of the endoscopic apparatus. The endoscopic procedure will be resumed only after a new disposable component with a new RFID tag replaces the invalid disposable component and only after the information on the new RFID tag has been again verified against the validation data.

Referring now to FIG. 4 it is schematically shown an example of the method, which ensures that the components of the colonoscopic apparatus will be operational only in a situation when the information received by the front-end interrogator/reader from the RFID tag is in compliance with the validation data. This method is carried out by the data processor 50 depicted in FIG. 3. As shown in FIG. 4, the information with the data received from the RFID tag proceeds to a first validation module 52, which verifies this data against the data within the validation database. The validation database is designated by the numeral 54 and it will be referred-to further as a valid/non-valid data. The non-valid data can contain types or models of the disposable component, which are obsolete or by some other reasons are not permitted for use. The valid/non-valid data can contain also additional data, like serial numbers of those components, which are prohibited for use, expiration dates and any other required information.

If the type or model received from the first validation module matches the non-valid data, in other words the disposable component in question is not permitted for use, or the data does not exist at all, the first validation module generates a System Disable signal 56 to terminate functioning of the system. Otherwise the information from the RFID tag proceeds for further validation.

It is shown in FIG. 4 that the valid/non-valid data can be remotely updated e.g. by linking to a manufacturer database 58 from which the fresh data could be uploaded.

If the type or model of the disposable component matches the valid model data the information from the RFID tag proceeds further to a second validation module, i.e. a serial number validation module 60. If the received serial number matches the non-valid serial number, or the data does not exist at all, the validation module 60 generates termination signal to disable the system. Otherwise the information from the RFID tag proceeds further to a further validation module 62, in which the expiration date is validated. The validation of the expiration date is carried out by comparing the expiration date programmed in the RFID tag with the current date, when the validation is carried out. There is provided also a supplemental validation module 64 for further validation of any other data, which may be programmed in the RFID tag.

If upon competition of the validation procedure all the data received from the RFID tag was found valid, a System Enable signal 66 is generated to enable the system. At the same time relevant information identifying the disposable component is displayed on the monitor and is stored in the processor for procedure record. This information enters also into a database with non-valid data in order to prevent a second use of the same disposable component.

It will thus be appreciated that the embodiments described above are cited by way of example, and that the present invention is not limited to what has been particularly shown and described hereinabove. Rather, the scope of the present invention includes both combinations and sub combinations of the various features described hereinabove, as well as variations and modifications thereof which would occur to persons skilled in the art upon reading the foregoing description and which are not disclosed in the prior art. Below is a partial list of such modifications.

So for example, the present invention would be suitable for use not only with colonoscopic apparatuses but with any other endoscopic apparatuses, e.g. gastroscopes, bronchoscopes, sigmoidoscopes, etc.

The present invention would be suitable for use with other disposable components, e.g. surgical tools, working channels etc.

The present invention would be suitable for use with disposable components, which are employed either in rigid or resilient endoscopes.

The present invention would be suitable for use with disposable components employed in endoscope, which is not provided with inflatable propelling sleeve.

It is not compulsory that the transceiver is able of interrogating the response signal.

The RFID tag can be reprogrammable so as to store new information.

Updating of valid/non-valid data may include not only addition of fresh information, but also changing of already stored information, e.g. change of designation of a model from valid to non-valid and vice versa.

I claim:

1. A disposable component of an endoscopic apparatus comprising a passive RFID tag programmed with identification information, wherein said RFID tag upon being energizing by a transceiver transmits the identification information to the transceiver.

2. The disposable component as per claim 1, wherein said disposable component being a sleeve for covering an insertion tube of the endoscopic apparatus.

3. The disposable component as per claim 1, wherein said disposable component being a lumen extending along an insertion tube of the endoscopic apparatus.

4. The disposable component as per claim 1, wherein said disposable component being a cap covering a distal end of an insertion tube of the endoscopic apparatus.

5. The disposable component as per claim 1, wherein said disposable component being a dispenser for storing a sleeve for covering an insertion tube of the endoscopic apparatus.

6. The disposable component as per claim 1, wherein said passive RFID tag being deployed in vicinity of the transceiver.

7. The disposable component as per claim 1, wherein said passive RFID tag being deployed remote from transceiver.

8. The disposable component as per claim 6, wherein said transceiver being deployed at an insertion tube of the endoscopic apparatus.

9. The disposable component as per claim 7, wherein said transceiver being deployed at a control unit of the endoscopic apparatus.

10. The disposable component as per claim 1, wherein the identification information comprises at least one item selected from the group consisting of a serial number, a lot number, a manufacturer name, a model number, a date for the end of use and a shipping date, or other data.

11. An endoscopic apparatus comprising an insertion tube, a working handle, a control unit and at least one disposable component provided with a passive RFID tag deployable on the disposable component and programmed with identification information, and a transceiver communicating with the passive RFID tag and energizing it, and wherein said RFID tag upon energizing transmits the identification information to the transceiver.

12. The endoscopic apparatus as per claim 11, wherein said disposable component is selected from the group consisting of a sleeve for covering the insertion tube, at least one lumen extending along the insertion tube, a cap covering distal end of the insertion tube, and a dispenser for storing the sleeve for covering the insertion tube.

13. The enodscopic apparatus as per claim 11, wherein said endoscopic apparatus being a gastrointestinal endoscopic apparatus.

14. The endoscopic apparatus as per claim 11, wherein said identification information comprises at least one item selected from the group consisting of a serial number, a lot number, a manufacturer name, a model number, a date for the end of use and a shipping date, or other data.

15. A method for tracking of a disposable component of an endoscopic apparatus to prevent intentional or inadvertent reuse of the component, its unauthorized use or use of a disapproved or non-ingenious disposable component, said method comprising the steps of:
providing a passive RFID tag programmed with identification information substantially referring to the disposable component,
deploying the RFID tag on the disposable component,
providing a transceiver,
transmitting an energizing signal from the transceiver to the RFID tag,
transmitting a response signal with the identification information from the RFID tag to the transceiver,
processing the identification information.

16. The method for tracking as defined in claim 15, comprising deployment of said transceiver in vicinity of the RFID tag.

17. The method for tracking as defined in claim 15, comprising deployment of said transceiver remote from the RFID tag.

18. The method for tracking as defined in claim 16, comprising deployment of said transceiver at the insertion tube.

19. The method for tracking as defined in claim 17, comprising deployment of said transceiver at a control unit of the endoscopic apparatus.

20. The method for tracking as defined in claim 15, wherein processing comprises validation of the identification information.
